(19) United States
(12) Patent Application Publication
(10) Pub. No.: US 2020/0067228 A1
(43) Pub. Date: Feb. 27, 2020

(54) ELECTRONIC APPARATUS AND CONNECTOR

(71) Applicant: SONY CORPORATION, TOKYO (JP)

(72) Inventors: TAKASHI YAMADA, TAIPEI (TW); MASAHIRO SHOHDA, TAIPEI (TW); EUGENE KANG, TAIPEI (TW); MARCEL CHENG, TAIPEI (TW); JACK HSU, TAIPEI (TW)

(21) Appl. No.: 16/466,363

(22) PCT Filed: Sep. 26, 2017
(86) PCT No.: PCT/JP2017/034713

§ 371 Date: Jun. 4, 2019

(30) Foreign Application Priority Data
Dec. 22, 2016 (JP) 2016-249448

(51) Int. Cl. H01R 13/502; H01R 13/66; H01R 13/631; H01R 24/62

(52) U.S. Cl. CPC H01R 13/5025; H01R 24/62; H01R 13/6315; H01R 13/6658

(57) ABSTRACT

There is provided an electronic apparatus including: a connector member that is electrically connected to an outside; a board; a flexible connection member that electrically connects the connector member to the board; and a housing in which the board is accommodated and to which the connector member is attached.

### TECHNICAL FIELD

The present disclosure relates to an electronic apparatus and a connector.

### BACKGROUND ART

Technologies for connectors provided in electronic apparatuses have been developed. Among such technologies, for example, there is the technology disclosed in Patent Literature 1 mentioned below.

### CITATION LIST

### Patent Literature

Patent Literature 1: JP 2016-91923A

### DISCLOSURE OF INVENTION

### Technical Problem

As speeds of data transmission between electronic apparatuses become higher and miniaturization of electronic apparatuses progresses further, for example, new connection interfaces such as those of Universal Serial Bus (USB) Type C have been introduced and higher functionality and further miniaturization of connectors in comparison to existing connectors have been in progress.

Here, in an existing connector such as the connector described in Patent Literature 1, for example, a connector member and a board are electrically bonded to each other by solder.

However, as miniaturization of connectors has progressed as described above, in a case in which a connector member and a board are bonded to each other by solder as in existing connectors, it is difficult to secure sufficient bonding strength for fixing the connector member to the board. In addition, in a case in which it is not possible to secure sufficient bonding strength for fixing the connector member to the board, there is concern of insufficient strength resulting in reliability of the connector deteriorating.

The present disclosure proposes a novel and improved electronic apparatus and connector that can improve reliability.

### Solution to Problem

According to the present disclosure, there is provided an electronic apparatus including: a connector member that is electrically connected to an outside; a board; a flexible connection member that electrically connects the connector member to the board; and a housing in which the board is accommodated and to which the connector member is attached.

In addition, according to the present disclosure, there is provided a connector including: a first connector member that is electrically connected to an outside; a second connector member that is electrically connected to the outside; and a flexible connection member that electrically connects the first connector member to the second connector member.

### Advantageous Effects of Invention

According to the present disclosure, reliability can be improved.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an example of a configuration of an existing electronic apparatus.

FIG. 2 is an explanatory diagram illustrating an example of a configuration of an electronic apparatus according to a first embodiment.

FIG. 3 is an explanatory diagram illustrating an example of a configuration of an electronic apparatus according to a second embodiment.

FIG. 4 is an explanatory diagram illustrating an example of a configuration of an electronic apparatus according to a third embodiment.

FIG. 5 is an explanatory diagram illustrating an example of a configuration of a connector according to the third embodiment.

FIG. 6 is an explanatory diagram illustrating an example of the configuration of the electronic apparatus in which the connector according to the third embodiment is used.

FIG. 7 is an explanatory diagram illustrating an example of a configuration of an electronic apparatus according to a fourth embodiment.

FIG. 8 is an explanatory diagram illustrating an example of a configuration of a connector according to the fourth embodiment.

FIG. 9 is an explanatory diagram illustrating an example of the configuration of the electronic apparatus in which the connector according to the fourth embodiment is used.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, “connection of one constituent component to another constituent component” described below means “electrical connection of the one constituent component to the other constituent component without passing through another constituent component” or “electrical connection of the one constituent component to the other constituent component through another constituent component.”

In addition, description will be provided below in the following order.

1. Overview of configuration of electronic apparatus and connector according to present embodiment
2. Electronic apparatus and connector according to first embodiment
3. Electronic apparatus and connector according to second embodiment
4. Electronic apparatus and connector according to third embodiment
5. Electronic apparatus and connector according to fourth embodiment
6. Examples of effects exhibited by electronic apparatus and connector according to present embodiment
7. Application examples of electronic apparatus and connector according to present embodiment

### [1] Overview of Configuration of Electronic Apparatus and Connector According to Present Embodiment

As methods of electrically connecting a plurality of electronic apparatuses using wires, for example, there are two methods: a “method of connecting a connection cable having connectors at both ends to connectors of two electronic apparatuses” and a “method of directly connecting connectors of two electronic apparatuses to each other.” In a case in which the “method of directly connecting connectors of two electronic apparatuses to each other” is used, for example, the connector of one electronic apparatus is a male connector, and the connector of the other electronic apparatus is a female connector.

The electronic apparatus and the connector according to the present embodiment can be applied to wired connection of the above-described two methods.

### [1-1] Example of Problem of Existing Electronic Apparatus

It is difficult to secure sufficient bonding strength for fixing a connector member to a board in a case in which the connector member is bonded to the board by solder as miniaturization of connectors progresses as described above. In addition, in a case in which it is not possible to secure sufficient bonding strength for fixing the connector member to the board, there is concern of insufficient strength resulting in deteriorating reliability of the connector.

Before the overviews of the configuration of the electronic apparatus and the connector according to the present embodiment are described, an example of a problem that may arise in existing electronic apparatuses will be described exemplifying an example of a configuration of an existing electronic apparatus.

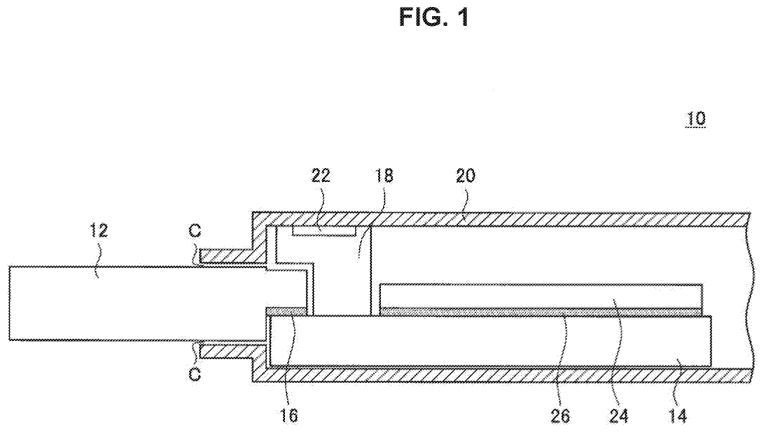

FIG. 1 is an explanatory diagram illustrating an example of a configuration of an existing electronic apparatus 10. FIG. 1 illustrates the example of the configuration in a case in which the electronic apparatus 10 is a USB memory.

The electronic apparatus 10 includes, for example, a connector member 12, a board 14, solder 16, a support member 18, a housing 20, an adhesive 22, a U3 connector 24, and solder 26.

The connector member 12 is a member electrically connected to the outside. In a case in which the electronic apparatus 10 is a USB memory, a connector member supporting the USB Type C, for example, is exemplified as the connector member 12.

Various members such as a processor are mounted on the board 14. Various kinds of processes relating to functions of the electronic apparatus 10, for example, data reading from a recording medium (not illustrated), data writing onto a recording medium (not illustrated), and the like are performed on the board 14. As the board 14, for example, a chip-on-board (COB) may be exemplified.

The solder 16 helps the connector member 12 to bond to the board 14 and thus electrically connects the connector member 12 to the board 14.

The support member 18 supports, for example, the member formed by bonding the connector member 12 to the board 14. As the support member 18, for example, a resin member such as a plastic holder may be exemplified.

The housing 20 is made of, for example, a metal and accommodates the board 14. In addition, the housing 20 has an opening having a size corresponding to the connector member 12, and the connector member 12 is disposed at the opening.

Here, in a case in which the connector member 12 is a connector member supported by the USB Type C, the size of the opening is the width size defined in the standard for USB Type C connectors. In addition, a certain gap is provided between the housing 20 and the connector member 12 as indicated by reference symbol C in FIG. 1.

The adhesive 22 causes the support member 18 to adhere to the housing 20. By the adhesive 22 causing the support member 18 to adhere to the housing 20, the member formed by bonding the connector member 12 to the board 14 is mechanically held by the support member 18 and fixed to the housing 20.

The U3 connector 24 is, for example, a connector member with a pattern supported by a USB 3.x standard.

The solder 26 bonds the board 14 to the U3 connector 24 and thus electrically connects the board 14 to the U3 connector 24.

The electronic apparatus 10 has, for example, the configuration illustrated in FIG. 1.

Here, the connector member 12 bonded to the board 14 through the solder 16 is soldered on a solder pad on a surface of the board 14. In addition, in a case in which the board 14 is a COB, for example, it is not possible to hold the connector member 12 and the board 14 by a claw-stop using through-holds of the board or the like.

As miniaturization of the electronic apparatus 10 progresses, the possibility that the solder pad on the surface of the board 14 will have to become smaller increases. Thus, as the miniaturization of the electronic apparatus 10 progresses, there is a limit on strength of the electronic apparatus 10 against an external force applied to the bonding part at which the connector member 12 is bonded to the board 14 through the solder 16 in a twisting direction (a direction orthogonal to a center line) and the insertion/removal direction of the connector member 12 (the left-right direction of FIG. 1). That is, as the electronic apparatus 10 is further miniaturized, it is more difficult to secure sufficient bonding strength for fixing the connector member 12 to the board 14.

In addition, in the case in which it is not possible to secure sufficient bonding strength for fixing the connector member 12 to the board 14, there is concern of the insufficient strength resulting in deteriorating reliability of the “configuration of the electronic apparatus 10 for electrical connection to the outside.”

### [1-2] Overview of Configuration of Electronic Apparatus According to Present Embodiment

First, an overview of a configuration of an electronic apparatus according to the present embodiment will be described.

An electronic apparatus according to the present embodiment has a connector member and a board electrically connected to each other by a flexible connection member. In the electronic apparatus according to the present embodiment, the board is accommodated in the housing and the connector member is attached to the housing.

The connector member according to the present embodiment is a member electrically connected to the outside.

As the connector member according to the present embodiment, for example, an arbitrary connector member that can connect the same type of electronic apparatuses or different types of electronic apparatuses such as a connector member supported by a USB standard, a connector member supported by the IEEE 1394 standard, a connector member supported by a local area network (LAN) standard, a connector member supported by a High-Definition Multimedia Interface (HDMI; registered trademark) standard, or the like may be exemplified.

In addition, the connector member according to the present embodiment may be a male connector or a female connector.

Various members such as a processor are mounted on the board according to the present embodiment and perform various processes relating to functions of the electronic apparatus according to the present embodiment.

As the board according to the present embodiment, for example, a COB or a printed circuit board (PCB) may be exemplified.

The flexible connection member according to the present embodiment is a member having flexibility and electrically connecting the connector member according to the present embodiment to the board according to the present embodiment.

As the flexible connection member according to the present embodiment, for example, a flexible printed circuit (FPC) or a flexible wire member may be exemplified.

The connector member according to the present embodiment and the board according to the present embodiment are electrically connected to each other when, for example, each of them is directly connected to the flexible connection member according to the present embodiment.

In addition, for example, the connector member according to the present embodiment may be electrically connected to the board according to the present embodiment when the connector member is directly connected to the flexible connection member according to the present embodiment and the board is indirectly connected to the flexible connection member. Here, the indirect connection to the flexible connection member means electrical connection to the flexible connection member via another member.

In addition, for example, the connector member according to the present embodiment may be electrically connected to the board according to the present embodiment when the connector member is indirectly connected to the flexible connection member according to the present embodiment and the board is directly connected to the flexible connection member.

Furthermore, the connector member according to the present embodiment and the board according to the present embodiment may be electrically connected to each other when, for example, each of them is indirectly connected to the flexible connection member according to the present embodiment.

The connector member according to the present embodiment and the board according to the present embodiment are electrically connected to each other when “each of the connector member according to the present embodiment and the board according to the present embodiment is directly connected to the flexible connection member according to the present embodiment” or “one or both of the connector member according to the present embodiment and the board according to the present embodiment are indirectly connected to the flexible connection member according to the present embodiment” as described above.

The electronic apparatus according to the present embodiment has the connector member according to the present embodiment and the board according to the present embodiment that are electrically connected to each other by the flexible connection member according to the present embodiment as described above. That is, in the electronic apparatus according to the present embodiment, the connector member according to the present embodiment and the board according to the present embodiment are electrically connected to each other via the flexible connection member according to the present embodiment, unlike in the electronic apparatus 10 illustrated in FIG. 1 in which the connector member is directly bonded to the board by soldering or the like.

Thus, in the electronic apparatus according to the present embodiment, even if an external force is applied to the connector member according to the present embodiment, the flexibility of the flexible connection member according to the present embodiment reduces the influence of the external force on the electrical connection of the connector member according to the present embodiment and the board according to the present embodiment. That is, the electronic apparatus according to the present embodiment secures strength against external forces applied to “the bonding part at which the connector member according to the present embodiment is bonded to the flexible connection member according to the present embodiment” and “the bonding part at which the flexible connection member according to the present embodiment is bonded to the board according to the present embodiment” in the twisting direction and the insertion/removal direction of the connector member according to the present embodiment.

In addition, since the strength against external forces is secured as described above, in the electronic apparatus according to the present embodiment, deterioration in reliability of “the configuration of the electronic apparatus according to the present embodiment relating to electrical connection to the outside” is prevented.

Thus, the electronic apparatus according to the present embodiment can improve reliability of the electronic apparatus according to the present embodiment.

Note that a configuration of the electronic apparatus according to the present embodiment is not limited to the above-described example.

The electronic apparatus according to the present embodiment may further include, for example, a support mechanism supporting the connector member according to the present embodiment, and the connector member according to the present embodiment may be attached to the housing through the support mechanism.

The support mechanism according to the present embodiment is a mechanism that supports the connector member according to the present embodiment so that the connector member moves in one or both of the horizontal direction and the vertical direction with respect to the insertion/removal direction of the connector member. In addition, the support mechanism according to the present embodiment may also function as a disengagement prevention mechanism that prevents disengagement of the connector member according to the present embodiment from the housing.

In addition, the electronic apparatus according to the present embodiment can also have, for example, a configuration according to an application example of the electronic apparatus according to the present embodiment which will be described below.

Examples of the configuration of the electronic apparatus according to the present embodiment having examples of the configuration of the support mechanism according to the present embodiment will be introduced in each embodiment which will be described below.

### [1-3] Overview of Configuration of Connector According to Present Embodiment

Next, an overview of a configuration of the connector according to the present embodiment will be described.

The connector according to the present embodiment electrically connects a first connector member to a second connector member using a flexible connection member.

The first connector member according to the present embodiment is one of connector members of the connector according to the present embodiment and plays a role of electrical connection to the outside.

As the first connector member according to the present embodiment, for example, an arbitrary connector member that can connect the same type of electronic apparatuses or different types of electronic apparatuses such as a connector member supported by a USB standard, a connector member supported by the IEEE 1394 standard, a connector member supported by a LAN standard, a connector member supported by an HDMI (registered trademark) standard, or the like may be exemplified. That is, the first connector member according to the present embodiment of the connector according to the present embodiment corresponds to the connector member according to the present embodiment of the above-described electronic apparatus according to the present embodiment.

The second connector member according to the present embodiment is another connector member of the connector according to the present embodiment and plays a role of electrical connection to the outside.

As the second connector member according to the present embodiment, for example, a connector member in an arbitrary shape electrically connected to the board according to the present embodiment may be exemplified.

Note that the second connector member according to the present embodiment is not limited to the above-described example. The second connector member according to the present embodiment may be, for example, a “connector member corresponding to the connector member according to the present embodiment of the above-described electronic apparatus according to the present embodiment.”

A case in which the second connector member according to the present embodiment is a connector member electrically connected to the board according to the present embodiment will be exemplified below.

In the connector according to the present embodiment, the first connector member according to the present embodiment is electrically connected to the second connector member according to the present embodiment by the flexible connection member according to the present embodiment.

In a case in which the connector according to the present embodiment is used, the first connector member according to the present embodiment and the board according to the present embodiment are electrically connected to each other via the flexible connection member according to the present embodiment and the second connector member according to the present embodiment, different from the connector member and the board of the electronic apparatus 10 being directly bonded to each other using soldering or the like as illustrated in FIG. 1.

Thus, even if an external force is applied to the first connector member according to the present embodiment in the case in which the connector according to the present embodiment is used, flexibility of the flexible connection member according to the present embodiment reduces the influence of the external force on the electrical connection of the first connector member according to the present embodiment to the second connector member according to the present embodiment. In addition, since the influence of the external force on the electrical connection of the first connector member according to the present embodiment to the second connector member according to the present embodiment is reduced, the influence of the external force on the electrical connection of the first connector member according to the present embodiment to the board according to the present embodiment is reduced as well.

That is, in the case in which the connector according to the present embodiment is used, strength against the external force applied to “the bonding part at which the first connector member according to the present embodiment is bonded to the flexible connection member according to the present embodiment” and “the bonding part at which the flexible connection member according to the present embodiment is bonded to the second connector member according to the present embodiment” in the twisting direction and the insertion/removal direction of the first connector member according to the present embodiment is secured.

In addition, since the strength against the external force is secured as described above, in the connector according to the present embodiment, degradation of reliability in the “configuration relating to the electrical connection of the connector according to the present embodiment to the outside” is prevented.

Thus, the connector according to the present embodiment can improve reliability of the connector according to the present embodiment or reliability of an electronic apparatus in which the connector according to the present embodiment is used.

An example of the configuration of the connector according to the present embodiment will be introduced in each embodiment which will be described below.

An example of the configuration of the above-described electronic apparatus according to the present embodiment and an example of the configuration of the above-described connector according to the present embodiment will be described below. Note that it is a matter of course that an example of the configuration of the electronic apparatus according to the present embodiment and an example of the configuration of the connector according to the present embodiment are not limited to the configurations according to the embodiment which will be described below. For example, the electronic apparatus according to the present embodiment can employ a configuration according to an application example of the electronic apparatus according to the present embodiment which will be described below.

### [2] Electronic Apparatus and Connector According to First Embodiment

### [2-1] Electronic Apparatus According to First Embodiment

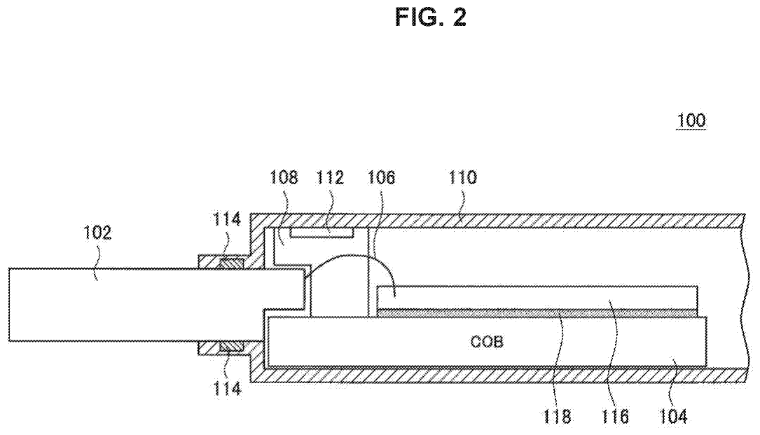

FIG. 2 is an explanatory diagram illustrating an example of a configuration of an electronic apparatus 100 according to a first embodiment. FIG. 2 illustrates an example of a configuration of a case in which the electronic apparatus 100 is a USB memory.

The electronic apparatus 100 includes, for example, a connector member 102, a COB 104, a flexible connection member 106, a support member 108, a housing 110, an adhesive 112, a welding spot 114, a U3 connector 116, and solder 118.

The connector member 102 is a member electrically connected to the outside and corresponds to the above-described connector member according to the present embodiment. In the case in which the electronic apparatus 100 is a USB memory, a connector member supported by the USB Type C, or the like, for example, may be exemplified as the connector member 102.

The COB 104 is a circuit board on which various members such as a processor are mounted using wire bonding, flip chip bonding, or the like. The COB 104 corresponds to an example of the board according to the present embodiment. Various kinds of processes relating to the functions of the electronic apparatus 100, for example, data reading from a recording medium (not illustrated), data writing onto a recording medium (not illustrated), and the like are performed on the COB 104.

The flexible connection member 106 electrically connects the connector member 102 to the COB 104. The flexible connection member 106 corresponds to the above-described flexible connection member according to the present embodiment.

In FIG. 2, an example in which one end of the flexible connection member 106 is electrically connected to the connector member 102 and the other end of the flexible connection member 106 is electrically connected to the U3 connector 116 that is electrically connected to the COB 104 is illustrated. That is, FIG. 2 illustrates an example in which the connector member 102 and the COB 104 are electrically connected to each other via a constituent component other than the flexible connection member 106, such as the U3 connector 116.

Note that a configuration of the electronic apparatus according to the first embodiment is not limited to the example illustrated in FIG. 2. For example, the electronic apparatus according to the first embodiment may employ a configuration in which one end of the flexible connection member 106 is electrically connected to the connector member 102 and the other end of the flexible connection member 106 is electrically connected to the COB 104. That is, the electronic apparatus according to the first embodiment can also employ the configuration in which the connector member 102 and the COB 104 are electrically connected to each other only via the flexible connection member 106.

The support member 108 supports the COB 104. As the support member 108, for example, a resin member such as a plastic holder may be exemplified.

The housing 110 is made of, for example, a metal and accommodates the COB 104. In addition, an opening having a size corresponding to the connector member 102 is formed in the housing 110, and the connector member 102 is attached at the opening. Here, in a case in which the connector member 102 is a connector member supported by the USB Type C, the size of the opening is the width size defined in the standard for USB Type C connectors.

The housing 110 is formed in a predetermined shape such as a box shape by, for example, die casting using a metal such as zinc. The housing 110 formed by die casting is formed, for example, as one body and is not divided.

The connector member 102 attached to the housing 110 is fixed to the housing 110 by, for example, being spot-welded at the welding spot 114. Since the connector member 102 is fixed to the housing 110 by spot-welding as illustrated in FIG. 2, mechanical strength of the housing 110 and the connector member 102 is secured in the electronic apparatus 100.

The adhesive 112 causes the support member 108 to adhere to the housing 1100. Since the support member 108 adheres to the housing 110 by the adhesive 112, the COB 104 is mechanically held by the support member 108 and is fixed to the housing 110.

The U3 connector 116 is, for example, a connector member with a pattern supported by a USB 3.x standard.

The solder 118 bonds the COB 104 to the U3 connector 116 and thus electrically connects the COB 104 to the U3 connector 116.

The electronic apparatus 100 according to the first embodiment has, for example, the configuration illustrated in FIG. 2.

Here, in the electronic apparatus 100, the connector member 102 and the COB 104 are electrically connected to each other by the flexible connection member 106.

Thus, the electronic apparatus 100 according to the first embodiment can improve reliability of the electronic apparatus 100.

In addition, the housing 110 is firmly bonded to the connector member 102 by welding in the electronic apparatus 100. Thus, it is possible to secure strength more rapidly and to secure mechanical reliability in the electronic apparatus 100 better than in the electronic apparatus 10 in which the connector member 12 is fixed to the board 14 through the solder 16 as illustrated in FIG. 1.

### [2-2] Connector According to First Embodiment

A connector according to the first embodiment includes, for example, a first connector member, a flexible connection member, and a second connector member.

As the first connector member, for example, the connector member 102 illustrated in FIG. 2 may be exemplified.

In addition, as the flexible connection member, for example, the flexible connection member 106 illustrated in FIG. 2 may be exemplified. One end of the flexible connection member is electrically connected to the first connector member and the other end of the flexible connection member is electrically connected to the second connector member.

The second connector member is, for example, a connector member electrically connected to a board such as the COB 104 or a connector member electrically connected to the board. As an example of the second connector member, a connector member 402, which will be described below, may be exemplified.

In the connector according to the first embodiment, the first connector member and the second connector member are electrically connected to each other by the flexible connection member.

Thus, the connector according to the first embodiment can improve reliability of the connector in the first embodiment or reliability of an electronic apparatus in which the connector in the first embodiment is used.

Note that the connector according to the first embodiment is not limited to the above-described example.

For example, the connector according to the first embodiment may include the connector member 102 and the flexible connection member 106.

The flexible connection member 106 electrically connects the connector member 102 to an electronic component.

The connector member 102 and the flexible connection member 106 are directly or indirectly connected. In addition, as electronic components electrically connected by the flexible connection member 106, for example, an external board of the connector according to the first embodiment such as an external COB or PCB of the connector according to the first embodiment, an external integrated circuit (IC) of the connector according to the first embodiment, and the like may be exemplified.

Also with the above-described configuration, the connector according to the first embodiment can improve reliability of the connector in the first embodiment or reliability of an electronic apparatus in which the connector in the first embodiment is used (an electronic apparatus having the external board or the external IC).

### [3] Electronic Apparatus and Connector According to Second Embodiment

### [3-1] Electronic Apparatus According to Second Embodiment

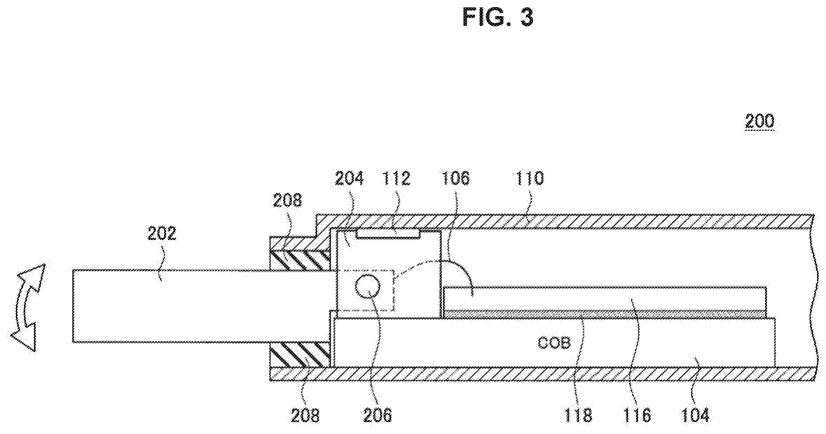

FIG. 3 is an explanatory diagram illustrating an example of a configuration of an electronic apparatus 200 according to a second embodiment. FIG. 3 illustrates an example of a configuration of a case in which the electronic apparatus 200 is a USB memory.

The electronic apparatus according to the second embodiment is a first example of the electronic apparatus having the support mechanism according to the present embodiment supporting a connector member. More specifically, the electronic apparatus according to the second embodiment is an example of an electronic apparatus having a “mechanism that causes a connector member to pivot in the horizontal direction or the vertical direction with respect to the insertion/removal direction of the connector member” as the support mechanism.

The electronic apparatus 200 has, for example, a connector member 202, a COB 104, a flexible connection member 106, a support member 204, a pin 206, a housing 110, an adhesive 112, a relaxing member 208, a U3 connector 116, and solder 118.

The configuration of each of the COB 104, the flexible connection member 106, the housing 110, the adhesive 112, the U3 connector 116, and the solder 118 and the electrical and mechanical relationship between each of the constituent components and other constituent components illustrated in FIG. 3 are similar to those of the electronic apparatus 100 illustrated in FIG. 2.

The connector member 202 is a member electrically connected to the outside and corresponds to the connector member according to the above-described present embodiment. In a case in which the electronic apparatus 200 is a USB memory, a connector member supported by the USB Type C or the like, for example, may be exemplified as the connector member 202.

In addition, the connector member 202 has a configuration in which the pin 206 can be mechanically connected.

The support member 204 supports the COB 104. As the support member 204, for example, resin member such as a plastic holder may be exemplified.

In addition, the support member 204 has a configuration in which the pin 206 can be mechanically connected.

The pin 206 is mechanically connected to the support member 204 and the connector member 202.

Since the pin 206 is mechanically connected to the support member 204 and the connector member 202, the connector member 202 is rotatably fixed to the support member 204 through the pin 206. In the example illustrated in FIG. 3, the connector member 202 rotates through the pin 206 in the top-bottom direction of FIG. 3.

Since the support member 204 and the connector member 202 are mechanically connected to the pin 206 as illustrated in FIG. 3, the connector member 202 pivots in the top-bottom direction of FIG. 3. In addition, the insertion/removal direction of the connector member 202 in FIG. 3 is the left-right direction of FIG. 3. That is, in the electronic apparatus 200 illustrated in FIG. 3, the configuration in which the support member 204 and the connector member 202 are mechanically connected to the pin 206 corresponds to a “mechanism that causes a connector member to pivot in the vertical direction with respect to the insertion/removal direction of the connector member.”

Note that a configuration of the electronic apparatus according to the second embodiment is not limited to the example illustrated in FIG. 3. Although the example in which the pin 206 is mechanically connected to the support member 204 and the connector member 202 in the depth direction of FIG. 3 is illustrated in FIG. 3, for example, the pin 206 may be mechanically connected to the support member 204 and the connector member 202 in the top-bottom direction of FIG. 3.

In a case in which the pin 206 is mechanically connected to the support member 204 and the connector member 202 in the top-bottom direction of FIG. 3, the connector member 202 pivots in the depth direction of FIG. 3. That is, in the case in which the pin 206 is mechanically connected to the support member 204 and the connector member 202 in the top-bottom direction of FIG. 3, the configuration in which the support member 204 and the connector member 202 are mechanically connected to the pin 206 corresponds to a “mechanism that causes a connector member to pivot in the horizontal direction with respect to the insertion/removal direction of the connector member.”

The relaxing member 208 is disposed between the housing 110 and the connector member 202 and relaxes an external force applied to the connector member 202. As the relaxing member 208, for example, a member formed in an arbitrary material that can relax an external force applied to the connector member 202 such as rubber may be exemplified.

When the relaxing member 208 applies appropriate pressure to the connector member 202 in the direction of pivot, for example, the connector member 202 that pivoted in the top-bottom direction of FIG. 3 returns to the position before the pivoting.

The electronic apparatus 200 according to the second embodiment has, for example, the configuration illustrated in FIG. 3.

Here, in the electronic apparatus 200, the connector member 102 and the COB 104 are electrically connected by the flexible connection member 106 as in the electronic apparatus 100 illustrated in FIG. 2.

Therefore, the electronic apparatus 200 according to the second embodiment can improve reliability of the electronic apparatus 200.

In addition, the electronic apparatus 200 includes the “mechanism that causes the connector member 202 to pivot in the horizontal direction or the vertical direction with respect to the insertion/removal direction of the connector member” and the relaxing member 208. Thus, since it is possible for the electronic apparatus 200 to avoid external forces applied to the connector member 202, the electronic apparatus 200 can secure more strength against external forces than the structure of the electronic apparatus 10 illustrated in FIG. 1 in which the connector member 12 is fixed to the board 14 through the solder 16.

### [3-2] Connector According to Second Embodiment

A connector according to the second embodiment has, for example, a first connector member, a flexible connection member, and a second connector member.

As the first connector member, for example, the connector member 202 illustrated in FIG. 3 may be exemplified.

In addition, as the flexible connection member, for example, the flexible connection member 106 illustrated in FIG. 2 may be exemplified. One end of the flexible connection member is electrically connected to the first connector member, and the other end of the flexible connection member is electrically connected to the second connector member.

The second connector member is, for example, a connector member electrically connected to a board such as the COB 104 or a connector member electrically connected to the board. As an example of the second connector member, the connector member 402, which will be described below, may be exemplified.

In the connector according to the second embodiment, the first connector member and the second connector member are electrically connected by the flexible connection member similarly to the connector according to the first embodiment.

Therefore, the connector according to the second embodiment can improve reliability of the connector in the second embodiment or reliability of an electronic apparatus in which the connector in the second embodiment is used.

Note that the connector according to the second embodiment is not limited to the above-described example.

The connector according to the second embodiment may have, for example, the connector member 202 and the flexible connection member 106.

The flexible connection member 106 electrically connects the connector member 202 to an electronic component.

The connector member 202 and the flexible connection member 106 are directly or indirectly connected. In addition, as electronic components electrically connected by the flexible connection member 106, for example, an external board of the connector according to the second embodiment, an external IC of the connector according to the second embodiment, and the like may be exemplified.

Even with the above-described configuration, the connector according to the second embodiment can improve reliability of the connector according to the second embodiment or reliability of an electronic apparatus in which the connector according to the second embodiment is used (an electronic apparatus having the external board or the external IC).

### [4] Electronic Apparatus and Connector According to Third Embodiment

### [4-1] Electronic Apparatus According to Third Embodiment

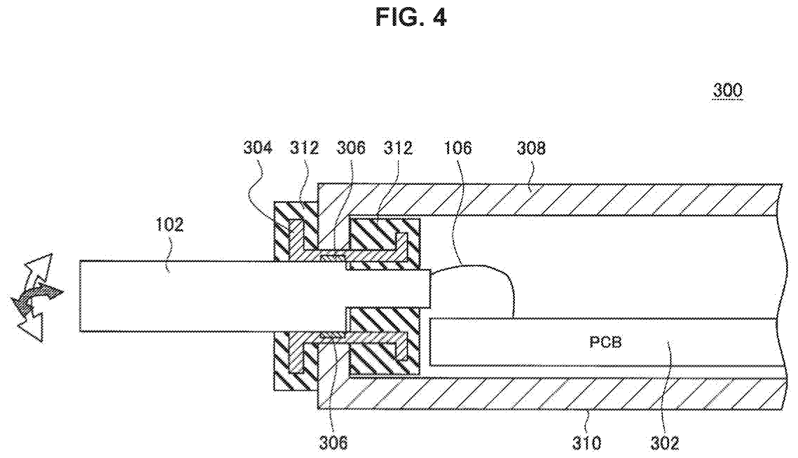

FIG. 4 is an explanatory diagram illustrating an example of a configuration of an electronic apparatus 300 according to a third embodiment. FIG. 4 illustrates an example of a configuration of a case in which the electronic apparatus 200 is an arbitrary electronic apparatus supported by a USB standard such as a reader/writer supported by the USB standard.

The electronic apparatus according to the third embodiment is a second example of the electronic apparatus having the support mechanism according to the present embodiment supporting a connector member. More specifically, the electronic apparatus according to the third embodiment is an example of the electronic apparatus having the support mechanism functioning as a disengagement prevention mechanism that prevents disengagement of the connector member from the housing.

The electronic apparatus 300 has, for example, a connector member 102, a PCB 302, a flexible connection member 106, a ring shape member 304, a welding spot 306, a first housing 308, a second housing 310, and a relaxing member 312. The ring shape member 304, the welding spot 306, and the relaxing member 312 correspond to the support mechanism functioning as the disengagement prevention mechanism.

The connector member 102 is a member electrically connected to the outside, like the connector member 102 illustrated in FIG. 2.

The PCB 302 is a circuit board on which electronic components are mounted. The PCB 302 corresponds to the board according to the present embodiment. On the PCB 302, various kinds of process relating to functions of the electronic apparatus 300, for example, a process for functioning as a reader/writer in near field communication (NFC) and the like, are performed.

The flexible connection member 106 electrically connects the connector member 102 to the PCB 302. The flexible connection member 106 corresponds to the above-described flexible connection member according to the present embodiment.

In FIG. 4, an example in which one end of the flexible connection member 106 is electrically connected to the connector member 102 and the other end of the flexible connection member 106 is electrically connected to the PCB 302.

Note that a configuration of the electronic apparatus according to the third embodiment is not limited to the example illustrated in FIG. 4. For example, the electronic apparatus according to the third embodiment may employ a configuration in which the connector member 102 and the PC 302 are electrically connected via a constituent component other than the flexible connection member 106.

The ring shape member 304 is, for example, a member formed by press-processing a sheet metal in a cylindrical or a C shape or a member formed by cutting out from a metallic rod material.

The ring shape member 304 is fixed to the connector member 102 by performing, for example, spot welding on the welding spot 306. Here, as a method for maintaining strength for welding the ring shape member 304 and the connector member 102, for example, one or both of methods of forming the ring shape member 304 of the same material as the connector member 102 and forming the ring shape member 304 in the same thickness as the connector member 102.

The relaxing member 312 is, for example, outsert-molded on a section of the ring shape member 304 formed in a U shape as one body. As the relaxing member 312, for example, a member formed in an arbitrary material that can relax an external force applied to the connector member 102, such as rubber, may be exemplified.

By outsert-molding the relaxing member 312 as one body as described above, the connector member 102, the ring shape member 304, and the relaxing member 312 constitute one 1 connector unit.

The first housing 308 and the second housing 310 are members forming a housing of the electronic apparatus 300.

The first housing 308 and the second housing 310 are fitted to each other so as to sandwich the connector unit therebetween. Since the first housing 308 and the second housing 310 are fitted to the connector unit, it is possible to removal of the connector member 102 from falling out in the insertion/removal direction of the connector member 102 (the left-right direction of FIG. 4) constituting the connector unit and the vertical direction to the insertion/removal direction (the top-bottom direction of FIG. 4).

That is, in the electronic apparatus 300, the connector unit constituted by the connector member 102, the ring shape member 304, and the relaxing member 312, the first housing 308, and the second housing 310 correspond to the “support mechanism functioning as a disengagement prevention mechanism that prevents disengagement of the connector member 102 and supporting the connector member 102.”

Having the support mechanism functioning as a disengagement prevention mechanism as described above, it is possible to cause “the connector member 102 to operate in each of the insertion/removal direction of the connector member 102 (the left-right direction of FIG. 4),” “the horizontal direction with respect to the insertion/removal direction (the depth direction of FIG. 4),” “the vertical direction to the insertion/removal direction (the top-bottom direction of FIG. 4),” and “the rotation direction with respect to the axis of the insertion/removal direction.” Thus, in the electronic apparatus 300, an external force applied to the connector member 202 can be avoided.

The electronic apparatus 300 according to the third embodiment has, for example, the configuration illustrated in FIG. 4.

Here, in the electronic apparatus 300, the connector member 102 and the PCB 302 are electrically connected by the flexible connection member 106.

Therefore, the electronic apparatus 300 according to the third embodiment can improve reliability of the electronic apparatus 300.

In addition, the electronic apparatus 300 has the support mechanism functioning as a disengagement prevention mechanism. Thus, since an external force applied to the connector member 102 in the electronic apparatus 300 can be avoided, more strength against external forces can be secured than in the structure of the electronic apparatus 10 illustrated in FIG. 1 in which the connector member 12 is fixed to the board 14 through the solder 16.

### [4-2] Connector According to Third Embodiment

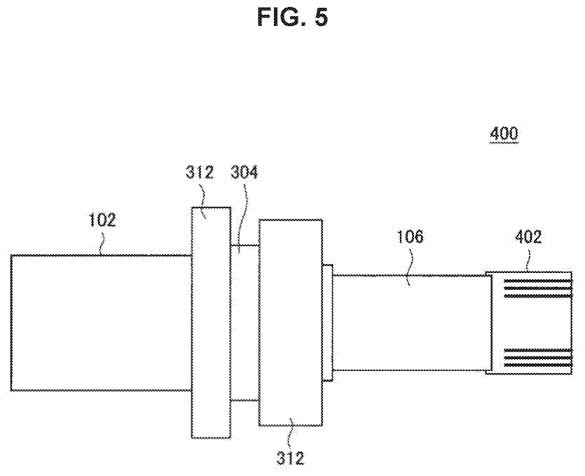

FIG. 5 is an explanatory diagram illustrating an example of a configuration of a connector 400 according to the third embodiment. The connector 400 has, for example, a connector member 102, a flexible connection member 106, a connector member 402, a ring shape member 304, and a relaxing member 312. In the connector 400, for example, the connector member 102 corresponds to a first connector member, and the connector member 402 corresponds to a second connector member.

The connector member 102, the ring shape member 304, and the relaxing member 312 illustrated in FIG. 5 constitute one connector unit, like the connector member 102, the ring shape member 304, and the relaxing member 312 illustrated in FIG. 4. Although not illustrated in FIG. 5, the ring shape member 304 is fixed to the connector member 102 by performing, for example, spot-welding on a welding spot 306 as in the electronic apparatus 300 illustrated in FIG. 4.

The flexible connection member 106 electrically connects the connector member 102 to the connector member 402. One end of the flexible connection member is electrically connected to the connector member 102 and the other end of the flexible connection member is electrically connected to the connector 400.

The connector member 402 is, for example, a connector member electrically connected to a board such as the COB 104 or a connector member electrically connected to the board.

The connector 400 according to the third embodiment has, for example, the configuration illustrated in FIG. 5. In the connector 400, the connector member 102 (first connector member) and the connector member 402 (second connector member) are electrically connected by the flexible connection member 106.

Therefore, the connector 400 can improve reliability of the connector 400 or reliability of the electronic apparatus in which the connector 400 is used.

Note that the connector according to the third embodiment is not limited to the above-described example.

For example, the connector according to the third embodiment may employ a configuration having the connector member 102, the flexible connection member 106, the ring shape member 304, and the relaxing member 312. The connector member 102, the ring shape member 304, and the relaxing member 312 constitute one connector unit, like the connector member 102, the ring shape member 304, and the relaxing member 312 illustrated in FIG. 4.

The flexible connection member 106 electrically connects the connector member 102 to an electronic component.

The connector member 102 and the flexible connection member 106 are directly or indirectly connected. In addition, as electronic components electrically connected by the flexible connection member 106, for example, an external board of the connector according to the third embodiment, an external IC of the connector according to the third embodiment, and the like may be exemplified.

Even with the above-described configuration, the connector according to the third embodiment can improve reliability of the connector according to the third embodiment or reliability of an electronic apparatus in which the connector according to the third embodiment is used (an electronic apparatus having the external board or the external IC).

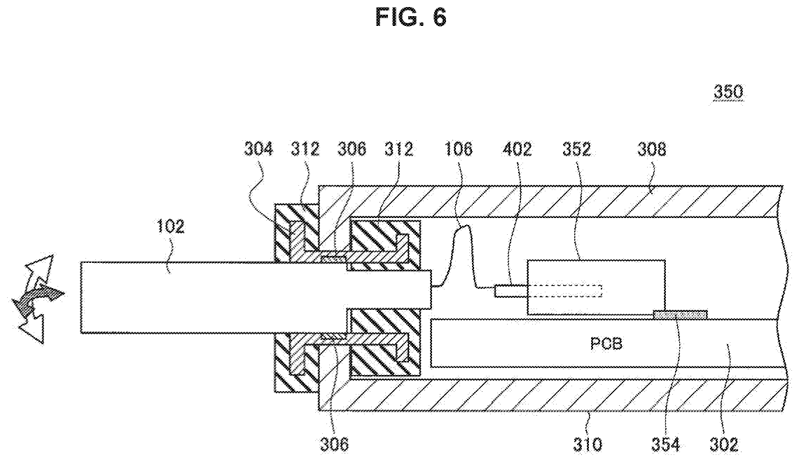

FIG. 6 is an explanatory diagram illustrating the example of the configuration of the electronic apparatus 350 in which the connector 400 according to the third embodiment is used.

The electronic apparatus 350 has, for example, a connector member 102, a PCB 302, a flexible connection member 106, a connector member 402, a ring shape member 304, a welding spot 306, a first housing 308, a second housing 310, a relaxing member 312, a connector member 352, and solder 354.

The connector member 102, the flexible connection member 106, the connector member 402, the ring shape member 304, and the relaxing member 312 illustrated in FIG. 6 correspond the connector 400 illustrated in FIG. 5.

In addition, the configuration of the first housing 308, and the second housing 310 and the mechanical connection relationship between each of the constituent components and other constituent components illustrated in FIG. 6 are similar to those of the electronic apparatus 300 illustrated in FIG. 4.

The connector member 352 is a connector member electrically connected to the connector member 402. The solder 354 bonds the PCB 302 to the connector member 352 and thus the PCB 302 and the connector member 352 are electrically connected.

The electronic apparatus 350 in which the connector 400 is used has, for example, the configuration illustrated in FIG. 6.

Since the connector member 402 constituting the connector 400 is electrically connected to the connector member 352 in the electronic apparatus 350 the connector member 102 constituting the connector 400 is electrically connected to the PCB 302.

### [5] Electronic Apparatus and Connector According to Fourth Embodiment

### [5-1] Electronic Apparatus According to Fourth Embodiment

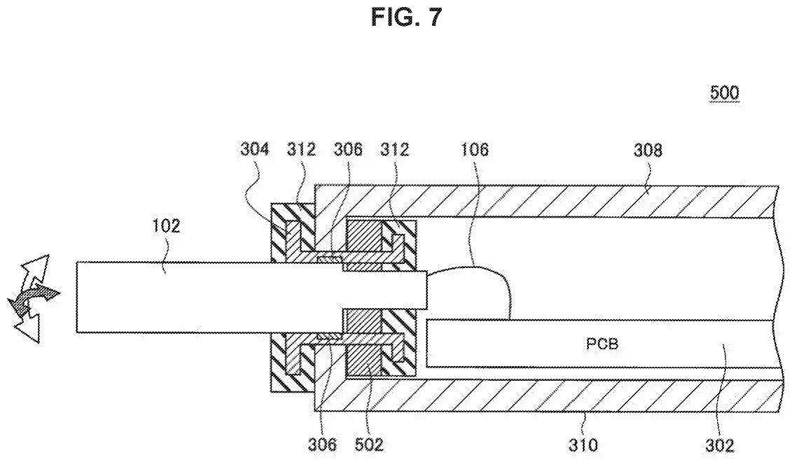

FIG. 7 is an explanatory diagram illustrating an example of a configuration of an electronic apparatus 500 according to a fourth embodiment. FIG. 7 illustrates an example of a configuration in a case in which the electronic apparatus 200 is an arbitrary electronic apparatus supported by a USB standard such as a reader/writer supported by the USB standard.

The electronic apparatus according to the fourth embodiment is a third example of the electronic apparatus having the support mechanism according to the present embodiment supporting a connector member. More specifically, the electronic apparatus according to the fourth embodiment is another example of the electronic apparatus having the support mechanism functioning as a disengagement prevention mechanism that prevents disengagement of the connector member from the housing.

The electronic apparatus 500 has, for example, a connector member 102, a PCB 302, a flexible connection member 106, a ring shape member 304, a welding spot 306, a first housing 308, a second housing 310, a relaxing member 312, and a spacer 502. The ring shape member 304, the welding spot 306, the relaxing member 312, and the spacer 502 correspond to the support mechanism functioning as a disengagement prevention mechanism.

The configuration of each of the connector member 102, the PCB 302, the flexible connection member 106, the ring shape member 304, the welding spot 306, the first housing 308, the second housing 310, and the relaxing member 312 and the electrical and mechanical connection relationships between each of the constituent components and other constituent components illustrated in FIG. 7 are similar to those of the electronic apparatus 300 illustrated in FIG. 4. In addition, when the configuration of the electronic apparatus 300 illustrated in FIG. 4 is compared to the electronic apparatus 500 illustrated in FIG. 7, there is the difference that the electronic apparatus 500 further has the spacer 502.

The spacer 502 is made of a material having a thickness and hardness one or both of which are adjustable, for example, rubber.

The spacer 502 is replaceable with respect to a connector unit constituted by the connector member 102, the ring shape member 304, and the relaxing member 312.

To give an example, the spacer 502 has a cylindrical shape and a slit or the like is made into a part of the spacer 502. By making a slit into the spacer 502 as described above, the spacer 502 can be mounted and removed after the formation of the connector unit.

With the configuration in which the spacer 502 is mounted into the connector unit as illustrated in FIG. 7, the connector unit can be a common item so that it can be applied to various electronic apparatuses.

In addition, one or both of a thickness and hardness can be adjusted with the spacer 502. Thus, pressure can be adjusted to be properly applied in each of the “horizontal direction with respect to the insertion/removal direction of the connector member 102 (the depth direction of FIG. 7),” the “vertical direction to the insertion/removal direction (the top-bottom direction of FIG. 7),” and the “rotation direction with respect to the axis of the insertion/removal direction” with the spacer 502.

The electronic apparatus 500 according to the fourth embodiment has, for example, the configuration illustrated in FIG. 7.

Here, the electronic apparatus 500 has basically a similar configuration to that of the electronic apparatus 300 illustrated in FIG. 4.

Therefore, the electronic apparatus 500 according to the fourth embodiment can improve reliability of the electronic apparatus 500, like the electronic apparatus 300 illustrated in FIG. 4. In addition, the electronic apparatus 500 according to the fourth embodiment can secure more strength against external forces than in the structure of the electronic apparatus 10 illustrated in FIG. 1 in which the connector member 12 is fixed to the board 14 through the solder 16, similarly to the electronic apparatus 300 illustrated in FIG. 4.

Furthermore, since the electronic apparatus 500 according to the fourth embodiment has the spacer 502, pressure can be adjusted to be properly applied in each of the “horizontal direction with respect to the insertion/removal direction of the connector member 102 (the depth direction of FIG. 7),” the “vertical direction to the insertion/removal direction (the top-bottom direction of FIG. 7),” and the “rotation direction with respect to the axis of the insertion/removal direction” in the electronic apparatus 500.

### [5-2] Connector According to the Fourth Embodiment

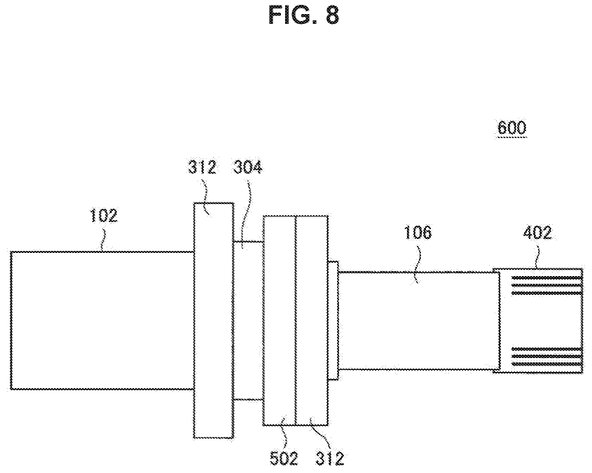

FIG. 8 is an explanatory diagram illustrating an example of a configuration of a connector 600 according to the fourth embodiment. The connector 600 has, for example, a connector member 102, a flexible connection member 106, a connector member 402, a ring shape member 304, a relaxing member 312, and a spacer 502. In the connector 600, for example, the connector member 102 corresponds to a first connector member, and the connector member 402 corresponds to a second connector member.

The configuration of each of the connector member 102, the flexible connection member 106, the connector member 402, the ring shape member 304, and the relaxing member 312 illustrated in FIG. 8 and the electrical and mechanical connection relation between each of the constituent components and other constituent components are similar to those of the connector 400 illustrated in FIG. 5. In addition, when the configuration of the connector 600 illustrated in FIG. 8 is compared to the connector 400 illustrated in FIG. 5, there is the difference that the connector 600 further has the spacer 502.

In addition, the spacer 502 is made of a material having a thickness and hardness one or both of which are adjustable and is replaceable with respect to the connector unit similarly to the spacer 502 of the electronic apparatus 500 illustrated in FIG. 7.

The connector 600 according to the fourth embodiment has, for example, the configuration illustrated in FIG. 8. In the connector 600, the connector member 102 (the first connector member) and the connector member 402 (the second connector member) are electrically connected by the flexible connection member 106, likewise in the connector 400 illustrated in FIG. 5.

Thus, the connector 600 can improve reliability of the connector 600 or reliability of the electronic apparatus in which the connector 600 is used, similarly to the connector 400 illustrated in FIG. 5.

In addition, the connector 600 has the spacer 502, likewise in the electronic apparatus 500 illustrated in FIG. 7. Thus, in the connector 600, pressure can be adjusted to be properly applied in each of the “horizontal direction with respect to the insertion/removal direction of the connector member 102 (the depth direction of FIG. 8),” the “vertical direction to the insertion/removal direction (the depth direction of FIG. 8),” and the “rotation direction with respect to the axis of the insertion/removal direction” similarly in the electronic apparatus 500 illustrated in FIG. 7.

Note that the connector according to the fourth embodiment is not limited to the above-described example.

For example, the connector according to the fourth embodiment may have the connector member 102, the flexible connection member 106, the ring shape member 304, the relaxing member 312, and the spacer 502. The configuration of each of the connector member 102, the flexible connection member 106, the ring shape member 304, the relaxing member 312, and the spacer 502 and the electrical and mechanical connection relationship between the constituent components and other constituent components are, for example, similar to those of the connector 600 illustrated in FIG. 8.

The flexible connection member 106 electrically connects the connector member 102 to an electronic component.

The connector member 102 and the flexible connection member 106 are directly or indirectly connected. In addition, as electronic components electrically connected by the flexible connection member 106, for example, an external board of the connector according to the fourth embodiment, an external IC of the connector according to the fourth embodiment, and the like may be exemplified.

Even with the above-described configuration, the connector according to the fourth embodiment can improve reliability of the connector according to the fourth embodiment or reliability of the electronic apparatus in which the connector according to the fourth embodiment is used (electronic apparatus having the above-described external board or external IC).

In addition, even with the above-described configuration, the connector according to the fourth embodiment can exhibit similar effects to those of the connector 600 illustrated in FIG. 8.

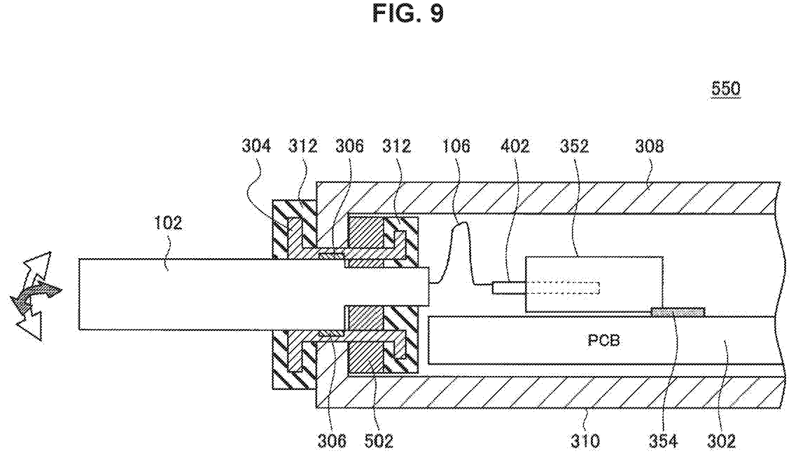

FIG. 9 is an explanatory diagram illustrating an example of a configuration of an electronic apparatus 550 in which the connector 600 according to the fourth embodiment is used.

The electronic apparatus 550 has, for example, a connector member 102, a PCB 302, a flexible connection member 106, a connector member 402, a ring shape member 304, a welding spot 306, a first housing 308, a second housing 310, a relaxing member 312, a spacer 502, a connector member 352, and solder 354.

The connector member 102, the flexible connection member 106, the connector member 402, the ring shape member 304, the relaxing member 312, and the spacer 502 illustrated in FIG. 9 correspond to the connector 600 illustrated in FIG. 8.

In addition, the configuration of the first housing 308 and the second housing 310 illustrated in FIG. 9 and the mechanical connection relationship between the constituent components and other constituent components are similar to those of the electronic apparatus 500 illustrated in FIG. 7.

In addition, the configuration of the connector member 352 and the solder 354 illustrated in FIG. 9 and the electrical connection relationship between the constituent components and other constituent components are similar to those of the electronic apparatus 350 illustrated in FIG. 6.

The electronic apparatus 550 in which the connector 600 is used has, for example, the configuration illustrated in FIG. 9.

Since the connector member 402 constituting the connector 600 is electrically connected to the connector member 352 in the electronic apparatus 550, the connector member 102 constituting the connector 600 is electrically connected to the PCB 302.

### [6] Examples of Effects Exhibited by Electronic Apparatus According to Present Embodiment and the Connector According to Present Embodiment

The electronic apparatus according to the present embodiment and the connector according to the present embodiment exhibit, for example, the following effects. Note that it is a matter of course that effects exhibited by the electronic apparatus according to the present embodiment and the connector according to the present embodiment are not limited to the following effects.
By not fixing a terminal of the connector (connector member) to a board (COB or PCB) using solder, twisting strength and separation strength of the connector can be increased more than the existing electronic apparatus 10, and thus reliability of the connector against external forces can be secured.
In a case in which a support mechanism that causes a tip of the connector (a tip of the connector member) to freely operate is provided, the support mechanism can help the connector avoid an external force applied to the connector when an external apparatus connected to the connector is attached or detached and thus reliability in attachment and detachment of the connector can be enhanced.
Even in a case in which an external force is applied to the connector in a use state in which the electronic apparatus having the connector is used while being connected to an external apparatus such as a host apparatus by the connector, damage given to each of the connector of the electronic apparatus and the connector of the external apparatus can be mitigated. Thus, the effect of improving reliability of the external apparatus such as the host apparatus in the use state and the effect of improving usability of the electronic apparatus and the external apparatus in the use state are expected.

### [7] Application Examples of Electronic Apparatus and Connector According to Present Embodiment

Although the electronic apparatus is exemplified above as the present embodiment, the present embodiment is not limited thereto. The present embodiment can be applied to various electronic apparatuses that can have connectors, for example, “storage devices such as USB memories,” “communication devices such as reader/writers and smartphones,” “computers such as personal computers (PCs) and servers,” “tablet type devices,” “game devices,” “cameras such as digital still cameras and digital video cameras,” “various mobile objects such as automobiles and motorcycles,” “apparatuses provided in mobile objects such as onboard equipment provided in automobiles,” “various wearable devices worn in bodies of users for use such as head-mount displays, eyewear-type devices, watch-type devices, bracelet-type devices” and the like.

In addition, although the connector has been exemplified as the present embodiment, the present embodiment is not limited thereto. The present embodiment can be applied to a connector that can be applied to the above-described electronic apparatus.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An electronic apparatus including:

a connector member that is electrically connected to an outside;

a board;

a flexible connection member that electrically connects the connector member to the board; and

a housing in which the board is accommodated and to which the connector member is attached.

(2)

The electronic apparatus according to (1), in which the board is a COB.

(3)

The electronic apparatus according to (1), in which the board is a PCB.

(4)

The electronic apparatus according to any one of (1) to (3), in which the flexible connection member is an FPC.

(5)

The electronic apparatus according to any one of (1) to (3), in which the flexible connection member is a flexible wire member.

(6)

The electronic apparatus according to any one of (1) to (5), in which each of the connector member and the board is directly connected to the flexible connection member.

(7)

The electronic apparatus according to any one of (1) to (5),

in which the connector member is directly connected to the flexible connection member, and

the board is indirectly connected to the flexible connection member.

(8)

The electronic apparatus according to any one of (1) to (7), further including:

a support mechanism that supports the connector member so that the connector member moves in one or both of a horizontal direction and a vertical direction with respect to an insertion/removal direction of the connector member,

in which the connector member is attached to the housing through the support mechanism.

(9)

The electronic apparatus according to (8), in which the support mechanism functions as a disengagement prevention mechanism that prevents disengagement of the connector member from the housing.

(10)

The electronic apparatus according to (8),

in which the support mechanism includes:

a mechanism that causes the connector member to pivot in the horizontal direction or the vertical direction; and

a relaxing member that is disposed between the housing and the connector member and relaxes an external force applied to the connector member.

(11)

The electronic apparatus according to any one of (1) to (10), in which the connector member is a male connector.

(12)

The electronic apparatus according to any one of (1) to (10), in which the connector member is a female connector.

(13)

A connector including:

a first connector member that is electrically connected to an outside;

a second connector member that is electrically connected to the outside; and

a flexible connection member that electrically connects the first connector member to the second connector member.

(14)

A connector including:

a connector member that is electrically connected to an outside; and

a flexible connection member that electrically connects the connector member to an electronic component.

### REFERENCE SIGNS LIST

10, 100, 200, 300, 350, 500, 550 electronic apparatus
12, 102, 202, 352 connector member
14 board
16, 26, 118, 354 solder
18, 108, 204 support member
20, 110 housing
22, 112 adhesive
24, 116 U3 connector
104 COB
106 flexible connection member
114, 306 welding spot
206 pin
302 PCB
304 ring shape member
308 first housing
310 second housing
312 relaxing member
400, 600 connector
402 connector member
502 spacer

1. An electronic apparatus comprising:
a connector member that is electrically connected to an outside;
a board;
a flexible connection member that electrically connects the connector member to the board; and
a housing in which the board is accommodated and to which the connector member is attached.

2. The electronic apparatus according to claim 1, wherein the board is a chip-on-board (COB).

3. The electronic apparatus according to claim 1, wherein the board is a printed circuit board (PCB).

4. The electronic apparatus according to claim 1, wherein the flexible connection member is a flexible printed circuit (FPC).

5. The electronic apparatus according to claim 1, wherein the flexible connection member is a flexible wire member.

6. The electronic apparatus according to claim 1, wherein each of the connector member and the board is directly connected to the flexible connection member.

7. The electronic apparatus according to claim 1,
wherein the connector member is directly connected to the flexible connection member, and
the board is indirectly connected to the flexible connection member.

8. The electronic apparatus according to claim 1, further comprising:
a support mechanism that supports the connector member so that the connector member moves in one or both of a horizontal direction and a vertical direction with respect to an insertion/removal direction of the connector member,
wherein the connector member is attached to the housing through the support mechanism.

9. The electronic apparatus according to claim 8, wherein the support mechanism functions as a disengagement prevention mechanism that prevents disengagement of the connector member from the housing.

10. The electronic apparatus according to claim 8,
wherein the support mechanism includes:
a mechanism that causes the connector member to pivot in the horizontal direction or the vertical direction; and
a relaxing member that is disposed between the housing and the connector member and relaxes an external force applied to the connector member.

11. The electronic apparatus according to claim 1, wherein the connector member is a male connector.

12. The electronic apparatus according to claim 1, wherein the connector member is a female connector.

13. A connector comprising:
a first connector member that is electrically connected to an outside;
a second connector member that is electrically connected to the outside; and
a flexible connection member that electrically connects the first connector member to the second connector member.

14. A connector comprising:
a connector member that is electrically connected to an outside; and
a flexible connection member that electrically connects the connector member to an electronic component.
